(19) United States
(12) Patent Application Publication
(10) Pub. No.: US 2026/0079001 A1
(43) Pub. Date: Mar. 19, 2026

(54) METHOD AND A SYSTEM FOR CHECKING DIMENSIONAL OR GEOMETRICAL FEATURES OF A MECHANICAL PART

(71) Applicant: Marposs Societa' Per Azioni, Bentivoglio (IT)

(72) Inventor: Ivan MASSARENTI, Lugo (RA) (IT)

(21) Appl. No.: 19/110,790

(22) PCT Filed: Sep. 14, 2023
(86) PCT No.: PCT/EP2023/075274

§ 371 Date: Mar. 11, 2025

(30) Foreign Application Priority Data
Sep. 16, 2022 (IT) 102022000018975

(51) Int. Cl. G01B 11/03; G01B 11/24; G06T 7/62; G06T 7/73

(52) U.S. Cl. CPC G01B 11/03; G01B 11/24; G06T 7/62; G06T 7/74

(57) ABSTRACT

A method for checking dimensions and geometrical features of a mechanical part using an optoelectronic system of the shadow casting type includes calculating the spatial coordinates of points of the surface of the part that allow a 3D reconstruction of the surface of the part, and checking the dimensions and geometrical features making use of such spatial coordinates. The spatial coordinates of the points are calculated starting from two-dimensional images and relevant profiles obtained by means of the shadow casting system while the mechanical part rotates about a rotation axis. The position of points or edges of the profiles and variation of such position are detected at predetermined heights as the rotation angle varies. On the basis of such variation, the position, with respect to a measurement plane, of points on the part to be checked which generate points of the aforementioned profile is identified and the spatial coordinates of the points of the surface are calculated.

### TECHNICAL FIELD

The present invention relates to a method and a system for checking dimensions or geometrical features of a three-dimensional mechanical part rotating about a rotation axis, by means of an optical system.

### BACKGROUND ART

It is known to carry out measurements and checkings of a three-dimensional mechanical part by means of an apparatus where the mechanical part can rotate about a rotation axis and images of the mechanical part are acquired by an optoelectronic system during the rotation, at corresponding sectional planes. More specifically it is known, in order to obtain extremely accurate results, to employ an optical measuring system of the shadow casting type including an emitter with a light source and telecentric lenses, a receiver with an optical sensor and a processing device. It is known that with such apparatuses it is possible to obtain extremely precise linear or bidimensional images of mechanical parts.

If the part to be checked has axial symmetry and is rotating about its own symmetry axis, it is possible to obtain proper information about the position of points of the whole surface of the part. But if the part has a different shape and/or does not rotate about its own symmetry axis, this is not generally possible, more specifically it is not possible to obtain, from the profiles extracted from the images acquired during the rotation at different sectional planes, a proper 3D reconstruction of the surface of the part. In fact, each two-dimensional image which is acquired during rotation of the mechanical part has a detected profile which does not necessarily correspond to the real profile of the mechanical part on the corresponding sectional plane: the points that make up the detected profile do not necessarily lie on such sectional plane and can be at different, unknown distances from the sectional plane, there is no information about it. Since a proper 3D reconstruction of the part, that is an evaluation of the position of points of the whole surface of the part, is not generally possible, the checking operations that can be carried out are consequently limited. This happens, for instance, in connection with mechanical parts featuring an external thread.

It is pointed out that systems and methods to obtain a 3D numerical object corresponding to a mechanical part to be checked are known and include, for example, coordinate measuring machines with contact sensors or apparatuses that use optoelectronic distance sensors such as laser scanners, suitably arranged and oriented with respect to the mechanical part to be controlled.

However, apparatuses with optoelectronic sensors of this type, although generally reliable and widely used, do not allow to obtain a three-dimensional numerical object which corresponds to the part to be controlled with the precision that in many cases is required and that can be obtained using the shadow casting measuring systems, this being caused, for example, by disturbances due to undesired reflectance phenomena.

### DISCLOSURE OF THE INVENTION

Object of the present invention is to provide a method and an apparatus for checking dimensions or geometrical features of a mechanical part by means of an optoelectronic system, more specifically an optical measuring system of the shadow casting type, that allow to obtain a 3D reconstruction of the mechanical part, that is to calculate the spatial coordinates of points of the surface of the mechanical part, and consequently to measure the part in a more accurate and complete way.

A checking method according to claim 1 and an apparatus according to claim 7 achieve this object.

In particular, the method according to the invention provides for rotating the mechanical part to be checked about a rotation axis, acquiring, at successive angles of rotation, two-dimensional images of the mechanical part by means of the optoelectronic system, extracting from each two-dimensional image, the points of a relative detected profile, transforming the points of each detected profile into the points of a measurement profile in a Cartesian reference system which includes a measurement plane and in which the axis of a first coordinate coincides with the rotation axis, identifying, in the Cartesian reference system, edge points of each measurement profile in correspondence of a same value of the first coordinate, evaluating the variation of the position of these edge points as a function of the angle of rotation and calculating on the basis of this variation the position of the points of the surface of the mechanical part corresponding to said edge points of the measurement profiles with respect to the measurement plane, and the spatial coordinates of such points.

The last two steps are repeated for a predetermined number of values of the first coordinate and the dimensional or geometrical features of the mechanical part are checked based on such spatial coordinates of the points.

### BRIEF DESCRIPTION OF THE DRAWINGS

The method and the apparatus according to the present invention will now be described with reference to the accompanying drawings, given by way of non-limiting example, in which

FIG. 1 shows in an extremely schematic way the essential components of a shadow casting system for the acquisition of two-dimensional images of a mechanical part,

FIG. 2A is a graphical representation of some profiles acquired by the system of FIG. 1 during the rotation of the mechanical part about the axis A of FIG. 1,

FIG. 2B is a graph of how the position of corresponding points of the profiles of FIG. 2A varies during rotation of the mechanical part about the axis A,

FIG. 3 is a schematic representation of a shadow casting system for checking a mechanical part defining an external thread, and

FIGS. 4 to 9 are graphical representations of the output of various steps in a checking process, taken as an example, of the mechanical part having an external thread.

### BEST MODES FOR CARRYING OUT THE INVENTION

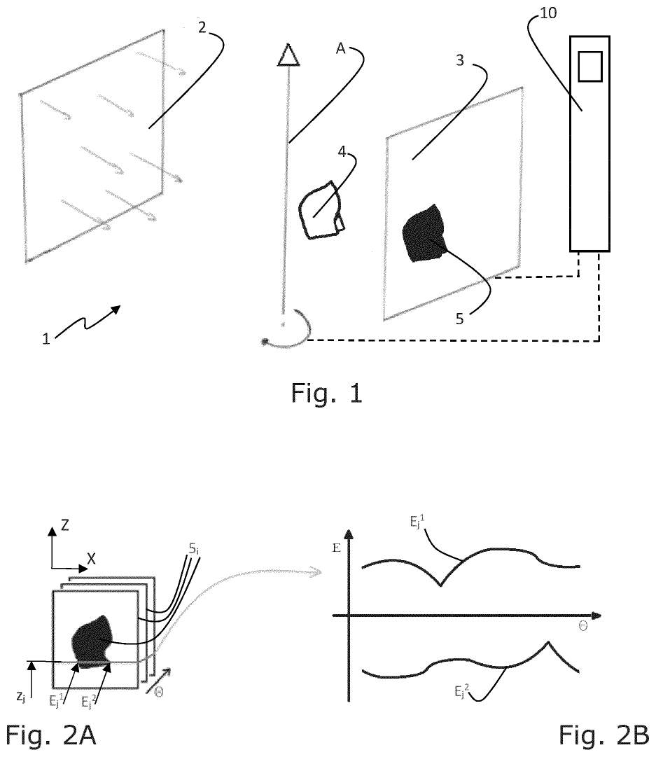

A checking apparatus including an optoelectronic system of the shadow casting type is shown in an extremely schematic manner in FIG. 1 and indicated with reference numeral 1. It comprises an emitter 2 with a light source and telecentric lenses and a receiver 3 with a sensor, more specifically e matrix sensor. A mechanical part 4 to be checked is arranged in a reference and support device and can rotate about a rotation axis A and the sensor 3 generates two-dimensional images 5ᵢ. A control and processing unit 10 is connected to the reference and support device to control the rotation of the mechanical part 4 and to the optoelectronic system to acquire the two-dimensional images at different angles of rotation θᵢ.

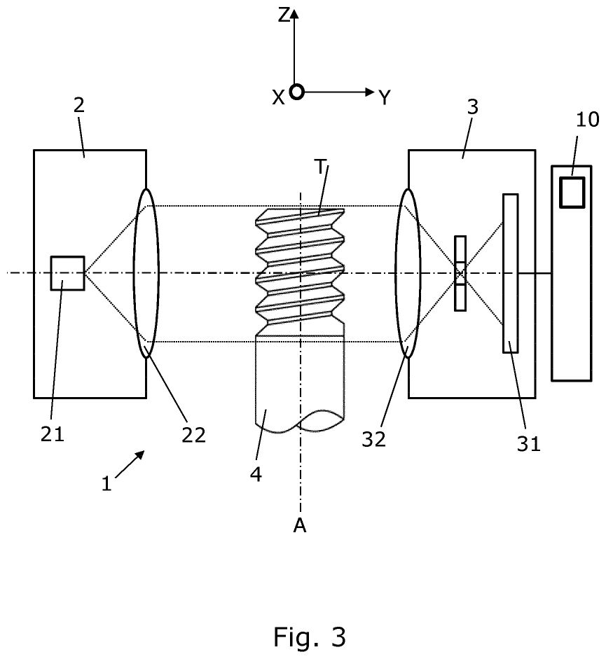

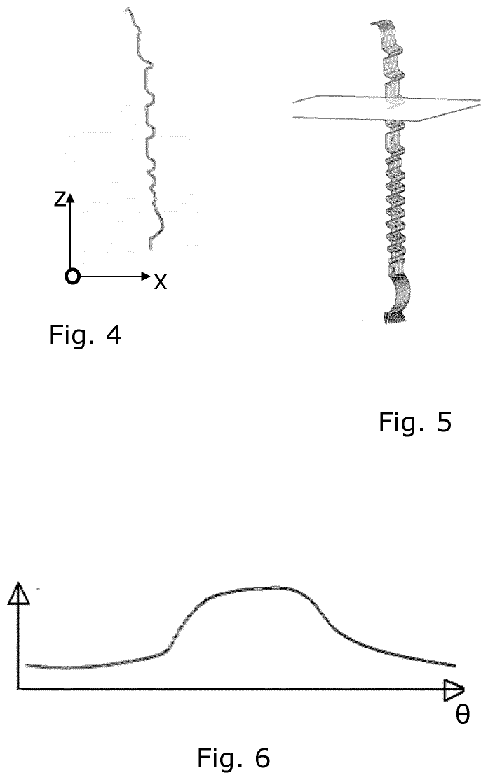

Detected values Eⱼ^{k} of the positions—or “edges”—of the profiles of said two-dimensional images 5ᵢ, i.e. the edge points of said profiles at a same zⱼ coordinate (or height) are grouped to obtain curves each representing how the value of each edge Eⱼ^{k} varies, more specifically representing the value of the respective coordinate x on the measurement plane XZ as a function of the angle of rotation θᵢ (FIG. 2B). In the example shown in the figure, the intersection between the line z=zⱼ and the profiles of the grouped two-dimensional images 5ᵢ generates two edges (k=1, k=2), but the number K of the generated edges varies and depends on the shape of the mechanical part 4 to be checked. The information about the depth, i.e. the distance of the point belonging to the surface of the mechanical part 4 which corresponds to the detected edge Eⱼ^{k} from the measurement plane XZ at a certain angle θᵢ, is obtained by calculating the variations of the aforesaid position as a function of the angle of rotation θ.

In practice, for each angle θᵢ and in the case of rotation of the mechanical part 4 in a clockwise direction with increasing angle θ (or rotation of the mechanical part 4 in an anti-clockwise direction with decreasing angle θ), the position in the space of each of the points pᵢ, that is the spatial coordinates of the points pᵢ of the surface of the mechanical part 4, at the height zⱼ is obtained by means of the following formula, where, as already mentioned before, Eⱼ^{k} is the value of one of the K edges generated at the height zⱼ, the one of order k (k=1, . . . , K):

$${p}_{i} = [ \begin{matrix}{p}_{x} \\ {p}_{y} \\ {p}_{z}\end{matrix} ] = [ \begin{matrix}{E}_{j}^{k} ( {θ}_{i} ) cos ( {θ}_{i} ) - \frac{{dE}_{j}^{k} ( {θ}_{i} )}{d {θ}_{i}} sin ( {θ}_{i} ) \\ + {E}_{j}^{k} ( {θ}_{i} ) sin ( {θ}_{i} ) + \frac{{dE}_{j}^{k} ( {θ}_{i} )}{d {θ}_{i}} cos ( {θ}_{i} ) \\ {z}_{j}\end{matrix} ]$$

In the case of rotation of the mechanical part 4 in a clockwise direction but with decreasing angle θ, or if the rotation of the mechanical part 4 is in an anticlockwise direction with increasing angle θ, the formula changes as follows

$${p}_{i} = [ \begin{matrix}{p}_{x} \\ {p}_{y} \\ {p}_{z}\end{matrix} ] = [ \begin{matrix}{E}_{j}^{k} ( {θ}_{i} ) cos ( {θ}_{i} ) - \frac{{dE}_{j}^{k} ( {θ}_{i} )}{d {θ}_{i}} sin ( {θ}_{i} ) \\ - {E}_{j}^{k} ( {θ}_{i} ) sin ( {θ}_{i} ) - \frac{{dE}_{j}^{k} ( {θ}_{i} )}{d {θ}_{i}} cos ( {θ}_{i} ) \\ {z}_{j}\end{matrix} ]$$

In summary, the formula for calculating the spatial coordinates of points pᵢ can be expressed as follows, where ± in both occurrences is + or is − depending on the direction of rotation of the mechanical part 4 and on whether the angle θ increases or decreases during such rotation:

$${p}_{i} = [ \begin{matrix}{p}_{x} \\ {p}_{y} \\ {p}_{z}\end{matrix} ] = [ \begin{matrix}{E}_{j}^{k} ( {θ}_{i} ) cos ( {θ}_{i} ) - \frac{{dE}_{j}^{k} ( {θ}_{i} )}{d {θ}_{i}} sin ( {θ}_{i} ) \\ \pm {E}_{j}^{k} ( {θ}_{i} ) sin ( {θ}_{i} ) \pm \frac{{dE}_{j}^{k} ( {θ}_{i} )}{d {θ}_{i}} cos ( {θ}_{i} ) \\ {z}_{j}\end{matrix} ]$$

It should be noted that the derivative, which provides information on the distance of the points of the profiles with respect to the measurement plane XZ, and hence the spatial coordinates of the points pᵢ of the surface of the mechanical part 4 corresponding to these points, can be calculated, for instance, by a suitable, numerical, per se known method.

The three-dimensional model is composed of a cloud, or set of points pᵢ with i=1, . . . , N obtained at the different predetermined heights zⱼ, with j=1, . . . , M.

A brief description follows of a particular preferred embodiment of the method according to the invention, which comprises other steps besides those mentioned above. In the shadow casting apparatus 1 of FIG. 1 the mechanical part 4 to be controlled, arranged between the emitter 2 and the receiver 3, is rotated about the rotation axis A, the latter defining the axis of a first coordinate Z of a Cartesian reference system S_{f}.

During the rotation of the mechanical part 4, N two-dimensional images 5ᵢ are acquired through the sensor 3 by the control and processing unit 10 at successive angles of rotation θᵢ which can, for example, cover, with predetermined frequency, a range of 180° or 360°. In particular, considering all the K edges at the height zⱼ and a whole 360° rotation, there is a certain redundancy of information since each point of the mechanical part 4 acquired at the angle θᵢ is also acquired at the angle θᵢ+180. As a consequence, in order to calculate all the spatial coordinates of the point pᵢ it is possible to take into consideration all the K edges in a 180° rotation or, as an alternative, K/2 edges in a whole, 360° rotation.

From each bidimensional image 5ᵢ a profile (“detected profile”) is extracted and the position of points Cᵢ(x,z) of the detected profile is identified in a reference system S_{c} associated with the sensor 3, in which the plane X_{c}Z_{c} coincides with the plane of the sensor 3.

The points Cᵢ(x,z) of the detected profile are transformed into points Fᵢ(x,z) of a corresponding profile (“measurement profile”) in the Cartesian reference system S_{f}, by means of parameters (transformation matrix and vector) obtained in a known manner in a calibration phase.

M values of the Z coordinate, or heights, zⱼ (j=1, . . . , M) are chosen at which the measurement profile is “sectioned”, that is the heights zⱼ of the points Fᵢ(x,z) of such measurement profile for which it is desired to evaluate the position in the space, and calculate the spatial coordinates, of the corresponding points of the real profile of the mechanical part 4.

The edges Eⱼ^{k} of the various measurement profiles are grouped so as to obtain at most K traces (K=maximum number of edges detectable during a rotation of the mechanical part 4) which describe the profile of the edges (i.e. of the respective coordinate x) as a function of the angle of rotation θ. In general, the edges are grouped so that the same trace includes the edges representing the same portion of the mechanical part 4 at different angles θᵢ. In general, the edges of two successive measurement profiles that are attributed to the same trace are those that have values (x coordinates) closest to each other.

The trend of the edge of k order (k=1, . . . , K) at the height zⱼ as the angle of rotation θᵢ varies; is defined as

$${E}_{j}^{k} ( {θ}_{i} )$$

The spatial coordinates of the points pᵢ generated by the edges defined above are obtained, as mentioned before, by applying the formula:

$${p}_{i} = [ \begin{matrix}{p}_{x} \\ {p}_{y} \\ {p}_{z}\end{matrix} ] = [ \begin{matrix}{E}_{j}^{k} ( {θ}_{i} ) cos ( {θ}_{i} ) - \frac{{dE}_{j}^{k} ( {θ}_{i} )}{d {θ}_{i}} sin ( {θ}_{i} ) \\ \pm {E}_{j}^{k} ( {θ}_{i} ) sin ( {θ}_{i} ) \pm \frac{{dE}_{j}^{k} ( {θ}_{i} )}{d {θ}_{i}} cos ( {θ}_{i} ) \\ {z}_{j}\end{matrix} ]$$

where, as already pointed out above, the sign ± in both occurrences is valid + or − depending on the direction of rotation of the mechanical part 4 and on the fact that the angle θ increases or decreases during such rotation.

The spatial coordinates of the points calculated for each height zⱼ (j=1, . . . , M) constitute the cloud (or the set) of points representing a three-dimensional numerical model of the mechanical part 4. The required checkings and measurements, for instance of geometrical or dimensional features of the mechanical part 4, are carried out in a per se known manner making use of or based on such spatial coordinates.

A method according to the present invention can be performed by means of an apparatus including an optoelectronic system with a matrix, bidimensional sensor as mentioned above, or with a different sensor. For instance, a linear, unidimensional sensor can be used. In this case, the two-dimensional images can be acquired, during the rotation of the mechanical part, by means a proper scanning in a direction parallel to the rotation axis A.

The method according to the invention allows to calculate the spatial coordinates of points pᵢ of the surface of a mechanical part 4 to be checked, so allowing more complete and accurate checking/measuring of geometrical and dimensional features of such mechanical part 4 with respect to the known methods employing optoelectronic systems of the shadow casting type, with bidimensional or linear sensors. It does so by analysing the instantaneous variations of the position of the profiles—detected from images provided by means of shadow casting techniques—so as to identify with good precision how the points of said profiles “move” during the rotation of the mechanical part 4 about the axis A. This allows to have the missing information on the distance of the points of the surface of the mechanical part corresponding to the points of the measurement profiles with respect to the measurement plane and then to calculate the spatial coordinates of the points that can be used to get a three-dimensional model of the mechanical part 4 and to carry out checkings/measurements of geometrical and/or dimensional features of such mechanical part 4.

It should be noted that the formula used in the preferred embodiment of the method according to the invention is always applicable, irrespective of the particular type of part.

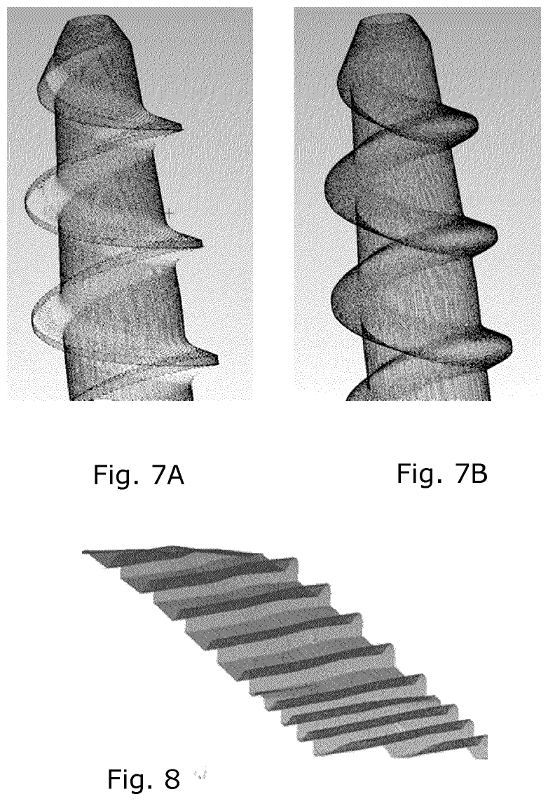

Making reference to FIGS. 3 to 9, an example of an apparatus and method according to the present invention will be described in connection with the checking of geometrical and dimensional features of a mechanical threaded part 4, having an outer profile with a helical development, that defines an external thread T and an operative axis. FIG. 3 schematically shows the optoelectronic system 1 of the shadow casting type including the emitter 2 with the light source 21 and the telecentric lenses 22 and the receiver 3 with proper optics 32 and the matrix sensor 31. The mechanical part 4 with the thread T is arranged in a reference and support device (not shown in FIG. 3) and can rotate about the rotation axis A that is parallel to coordinate Z and in general does not coincide with the operative axis, contrary to what may appear in FIG. 3. The receiver 3 is connected to the processing and control unit 10 that acquires the two-dimensional images of the thread T at different angles of rotation θᵢ.

It is noted that, due to the helical development of the surface, the contour of the image of a thread acquired using shadow casting techniques is generated by points that do not belong to a single sectional plane. That is, the points of the measurement profile, obtained from the detected profile extracted from the acquired image (shadow) correspond to points of the surface of the thread T not lying on each sectional or measurement plane (making reference to FIG. 3, the plane XZ including axis A), at different, unknown distances from the measurement plane. As a consequence, in order to get a profile that approximate the true profile of the thread so as to allow proper checking/measuring operations, it is necessary to apply algorithms to correct this “error” due to the geometry of the part and to detect or calculate the distance of each point of the measurement profile from the measurement plane of the optoelectronic system.

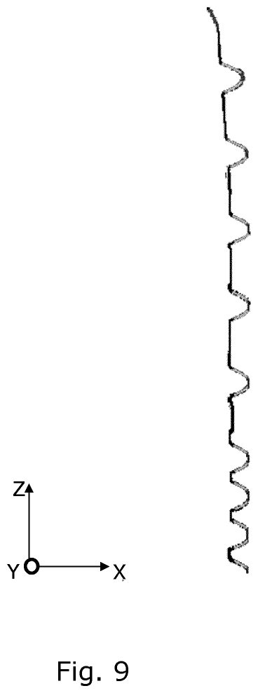

During the rotation of the part 4 with the thread T, rotation that must not necessarily be centred with respect to the rotation axis A, a sufficiently high number of images are generated by the sensor 31 and acquired by the processing and control unit 10. The angle of rotation θᵢ is memorized for each image and for each image a detected profile is extracted. Curves are obtained which lie on the XZ plane. Using the axis calibration, the detected profiles are roto-translated so that the Z axis coincides with the rotation axis. A measurement profile obtained as a result is shown in FIG. 4.

The information about the angle of rotation θᵢ is used as the X axis in order to “pack” the various curves in an XYZ system.

The number M of different sections at the heights zⱼ is defined and the above-mentioned packed curves are sectioned with planes parallel to the XY plane and lying at the different zⱼ heights (FIG. 5). For each zⱼ and each edge k, a function is obtained which expresses the trend of the points of the measurement profile as the rotation angle θ varies (FIG. 6):

$${E}_{j}^{k} ( θ )$$

A derivative of such function is calculated with suitable procedures and the spatial coordinates of the points pᵢ of the surface can be obtained with the already cited formula that is here repeated:

$${p}_{i} = [ \begin{matrix}{p}_{x} \\ {p}_{y} \\ {p}_{z}\end{matrix} ] = [ \begin{matrix}{E}_{j}^{k} ( {θ}_{i} ) cos ( {θ}_{i} ) - \frac{{dE}_{j}^{k} ( {θ}_{i} )}{d {θ}_{i}} sin ( {θ}_{i} ) \\ \pm {E}_{j}^{k} ( {θ}_{i} ) sin ( {θ}_{i} ) \pm \frac{{dE}_{j}^{k} ( {θ}_{i} )}{d {θ}_{i}} cos ( {θ}_{i} ) \\ {z}_{j}\end{matrix} ]$$

The spatial coordinates so obtained forms a cloud of points which represent the piece in a rather realistic way (FIG. 7A).

FIG. 7B shows the same threaded part as can be reconstructed by means of a method according to the background art, without applying the method of the present invention, i.e. considering the points of the measurement profile as corresponding to points of the surface of the part all lying on the same measurement plane. The model of FIG. 7B has portions not corresponding to the actual surface of the threaded part to be checked and consequently the points forming such model do not allow to carry out accurate checkings of geometrical and dimensional features of the threaded part.

The spatial coordinates obtained according to the method of the present invention are roto-translated in a reference system with the Z axis coinciding with the operative axis of the thread. This can be achieved with an appropriate segmentation of the areas of the thread T from the measurement profiles to obtain the thread axis. For example, managing to isolate the points belonging to the crests of the thread, after the application of the above formula they could be part of a cylinder (or of a cone) whose axis can be calculated. Areas of the mechanical part 4 outside the threaded area might also be used to obtain the same axis.

In such a way, it is possible to obtain curves lying on a plane which contains the operative axis, or to calculate cylindrical coordinates of the points pᵢ (FIG. 8) to obtain at each defined angle θᵢ the points which lie on an axial plane. From the curves obtained in such a way it is possible to extract, with appropriate segmentation algorithms, the profiles of the thread that represent in a realistic way the true profile of the thread T (FIG. 9), so providing the desired accurate information about the dimensional and geometric features of the mechanical part 4.

1. A method for checking dimensions or geometrical features of a mechanical part, the method comprising:
rotating the mechanical part about a rotation axis;
acquiring, at successive angles of rotation, two-dimensional images of the mechanical part using an optoelectronic system;
extracting, from each two-dimensional images, points of a detected profile;
transforming the points of each detected profile into points of a measurement profile in a Cartesian reference system which includes a measurement plane and in which an axis of a first coordinate coincides with the rotation axis;
identifying, in the Cartesian reference system, edge points of each measurement profile in correspondence of a same value of the first coordinate;
evaluating the variation of the positions of the edge points as a function of the angle of rotation and calculating, based on the variation, the positions of the points of the surface of the mechanical part corresponding to the edge points of the measurement profiles with respect to the measurement plane, and the spatial coordinates of the points of the surface of the mechanical part;
repeating the identifying and evaluating steps for a predetermined number of values of the first coordinate; and
checking dimensions or geometrical features of the mechanical part based on the spatial coordinates of the points.

2. The method of claim 1, wherein evaluating the variation of the positions of the edge points as a function of the angle of rotation and calculating, based on the variation, the positions of the points of the surface of the mechanical part corresponding to the edge points of the measurement profiles with respect to the measurement plane, and the spatial coordinates of the points of the surface of the mechanical part includes applying the following formula:
$${p}_{i} = [ \begin{matrix}{p}_{x} \\ {p}_{y} \\ {p}_{z}\end{matrix} ] = [ \begin{matrix}{E}_{j}^{k} ( {θ}_{i} ) cos ( {θ}_{i} ) - \frac{{dE}_{j}^{k} ( {θ}_{i} )}{d {θ}_{i}} sin ( {θ}_{i} ) \\ \pm {E}_{j}^{k} ( {θ}_{i} ) sin ( {θ}_{i} ) \pm \frac{{dE}_{j}^{k} ( {θ}_{i} )}{d {θ}_{i}} cos ( {θ}_{i} ) \\ {z}_{j}\end{matrix} ]$$
wherein:
$${E}_{j}^{k} ( {θ}_{i} )$$
represents the trend, as the angle of rotation (θᵢ) varies, of the edge point of order k (k=1, . . . , K) at a same value (zⱼ) of the first coordinate (Z), and
the ± sign:
is a plus sign in the case of clockwise rotation of the mechanical part with an increasing angle of rotation (θ) or counterclockwise rotation of the mechanical part with a decreasing angle of rotation (θ), or
is a minus sign in the case of counterclockwise rotation of the mechanical part with an increasing angle of rotation (θ) or clockwise rotation of the mechanical part with a decreasing angle of rotation (θ).

3. The method of claim 1, wherein the two-dimensional images of the mechanical part are acquired using a bidimensional sensor of the optoelectronic system.

4. The method of claim 1, wherein the two-dimensional images of the mechanical part are acquired using a linear sensor of the optoelectronic system.

5. The method of claim 1, wherein the mechanical part defines an external thread and an operative axis.

6. The method of claim 5, further comprising:
roto-translating the spatial coordinates in a reference system in which the axis of the first coordinate coincides with the operative axis; and
extracting a profile of the external thread.

7. An apparatus for checking dimensions or geometrical features of a mechanical part, the apparatus comprising:
a reference and support device adapted to rotatably support the mechanical part to be checked, the reference and support device defining a rotation axis;
an optoelectronic system; and
a control and processing unit connected to the reference and support device and to the optoelectronic system, the control and processing unit being adapted to:
control the rotation of the mechanical part about the rotation axis;
acquire, at successive angles of rotation, two-dimensional images of the mechanical part using the optoelectronic system;
extract, from each two-dimensional image, points of a detected profile;
transform the points of each detected profile into points of a measurement profile in a Cartesian reference system which includes a measurement plane and in which an axis of a first coordinate coincides with the rotation axis;
identify, in the Cartesian reference system, edge points of each measurement profile in correspondence of a same value of the first coordinate;
evaluate the variation of the positions of the edge points as a function of the angle of rotation and calculate, based on the variation, the positions of the points of the surface of the mechanical part corresponding to the edge points of the measurement profiles with respect to the measurement plane, and the spatial coordinates of the points of the surface of the mechanical part;
repeat the identification and evaluation for a predetermined number of values of the first coordinate; and
check dimensions or geometrical features of the mechanical part based on the spatial coordinates of the points.

8. The method of claim 1, wherein the optoelectronic system is of the shadow-casting type and comprises linear or matrix sensors and telecentric optics.

9. The method of claim 4, wherein the linear sensor of the optoelectronic system scans the mechanical part in a direction parallel to the rotation axis.

10. The apparatus of claim 7, wherein the optoelectronic system is of the shadow-casting type and comprises linear or matrix sensors and telecentric optics.

11. The apparatus of claim 7, wherein evaluation of the variation of the positions of the edge points as a function of the angle of rotation and calculation, based on the variation, of the positions of the points of the surface of the mechanical part corresponding to the edge points of the measurement profiles with respect to the measurement plane, and the spatial coordinates of the points of the surface of the mechanical part includes applying the following formula:
$${p}_{i} = [ \begin{matrix}{p}_{x} \\ {p}_{y} \\ {p}_{z}\end{matrix} ] = [ \begin{matrix}{E}_{j}^{k} ( {θ}_{i} ) cos ( {θ}_{i} ) - \frac{{dE}_{j}^{k} ( {θ}_{i} )}{d {θ}_{i}} sin ( {θ}_{i} ) \\ \pm {E}_{j}^{k} ( {θ}_{i} ) sin ( {θ}_{i} ) \pm \frac{{dE}_{j}^{k} ( {θ}_{i} )}{d {θ}_{i}} cos ( {θ}_{i} ) \\ {z}_{j}\end{matrix} ]$$
wherein:
$${E}_{j}^{k} ( {θ}_{i} )$$
represents the trend, as the angle of rotation (θᵢ) varies, of the edge point of order k (k=1, . . . , K) at a same value (zⱼ) of the first coordinate (Z), and
the ± sign:
is a plus sign in the case of clockwise rotation of the mechanical part with an increasing angle of rotation (θ) or counterclockwise rotation of the mechanical part with a decreasing angle of rotation (θ), or
is a minus sign in the case of counterclockwise rotation of the mechanical part with an increasing angle of rotation (θ) or clockwise rotation of the mechanical part with a decreasing angle of rotation (θ).

12. The apparatus of claim 7, wherein the optoelectronic system comprises a bidimensional sensor configured to acquire the two-dimensional images of the mechanical part.

13. The apparatus of claim 7, wherein the optoelectronic system comprises a linear sensor configured to acquire the two-dimensional images of the mechanical part.

14. The apparatus of claim 13, wherein the linear sensor of the optoelectronic system scans the mechanical part in a direction parallel to the rotation axis.

15. The apparatus of claim 7, wherein the mechanical part defines an external thread and an operative axis.

16. The apparatus of claim 15, wherein the control and processing unit is further adapted to:
roto-translate the spatial coordinates in a reference system in which the axis of the first coordinate coincides with the operative axis; and
extract a profile of the external thread.
